(19) United States
(12) Patent Application Publication
(10) Pub. No.: US 2014/0000103 A1
(43) Pub. Date: Jan. 2, 2014

(54) METHOD OF ACCESSING EMBEDDED ELEMENTS OF A CABLE

(71) Applicant: Christopher Lambert, Blacksburg, VA (US)

(72) Inventor: Christopher Lambert, Blacksburg, VA (US)

(73) Assignee: BAKER HUGHES INCORPORATED, Houston, TX (US)

(21) Appl. No.: 13/539,792

(22) Filed: Jul. 2, 2012

(51) Int. Cl. G02B 6/25; H01B 13/00

(52) U.S. Cl. CPC G02B 6/25; H01B 13/00
USPC 29/825; 29/426.4; 29/426.2

(57) ABSTRACT

A method of accessing one or more conductor elements embedded in a solid medium in a cable. The method includes heating the cable to a temperature that is greater than a first transition temperature corresponding to the medium and less than a second transition temperature corresponding to the one or more conductor elements, softening the medium by the heating; and removing at least one of the one or more conductor elements at least partially from the medium.

### BACKGROUND

Fiber optic sensing cables are used ubiquitously in the downhole drilling and completions industry, among others. The fiber optic cables are used, for example, to sense a variety of downhole conditions or parameters such as temperature, pressure, acoustics, strain in a structural component with which the cable is arranged, etc. In one type of sensing cable the fiber optic strands are embedded in a solid filler medium. Due to the embedded condition of the fiber optic strands, access to the strands is not easily possible, making tasks such as splicing the cable difficult. In view of the foregoing, the industry would well receive a method of gaining access to the embedded fibers or other conductor elements, particularly for the purpose of facilitating the process of splicing the cable.

### SUMMARY

A method of accessing one or more conductor elements embedded in a solid medium in a cable, including heating the cable to a temperature that is greater than a first transition temperature corresponding to the medium and less than a second transition temperature corresponding to the one or more conductor elements; softening the medium by the heating; and removing at least one of the one or more conductor elements at least partially from the medium.

### BRIEF DESCRIPTION OF THE DRAWINGS

The following descriptions should not be considered limiting in any way. With reference to the accompanying drawings, like elements are numbered alike:

FIG. 1 illustrates a cable being heated to enable removal of an embedded conductor element; and

FIG. 2 schematically illustrates a cross-section of the cable taken generally along the line 2-2 in FIG. 1.

### DETAILED DESCRIPTION

A detailed description of one or more embodiments of the disclosed apparatus and method are presented herein by way of exemplification and not limitation with reference to the Figures.

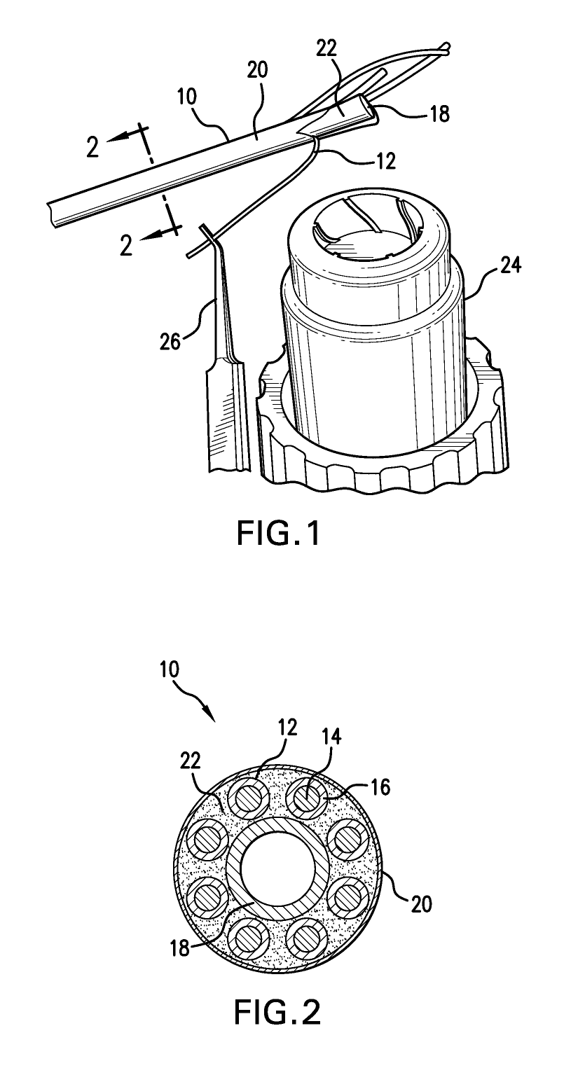

A cable 10 is illustrated according to one embodiment in FIGS. 1 and 2. The cable 10 includes one or more conductor elements 12 which are arranged to sense various conditions or parameters, such as temperature, pressure, strain, acoustics, vibration, etc. and/or to enable the transmission of electrical power, data, signals, etc. therethrough. In the illustrated embodiment, each of the conductor elements 12 includes a fiber optic strand 14 having a protective coating or jacket 16. The fiber optic strands 14 could include fiber Bragg gratings or be otherwise arranged to sense the aforementioned conditions and parameters. Additionally, the elements 12 could be other signal conductors, e.g. wires, control lines, etc. capable of transmitting a data or signal therethrough. In one embodiment the coating or jacket 16 is polymeric and can be, e.g., extruded onto the fibers 14.

The conductor elements 12 are included circumferentially about a core or central member 18. The elements 12 could be wrapped, e.g., spirally or helically, or extend essentially parallel to the central member 18. The fiber optic strands 14 may be disposed radially outwardly of the central member 18 particularly for the purpose of enabling the cable 10 to sense strain, via the fiber optic strands 14, in a structure with which the cable 10 is deployed, e.g., a downhole tubular string. The member 18 in the illustrated embodiment takes the form of a hollow tube, although it could also be arranged as a solid wire. Of course, when embodied as a hollow tube as shown, the member 18 is able to house additional fibers, wires, conductors, etc., which are not arranged for sensing strain, but which are generally protected by their placement within the tube. In either case, the central member 18 provides some rigidity, compressive and tensile strength, structural integrity, etc. to the cable 10, e.g., for facilitating the use and installation of the cable 10.

A cladding 20 is included to surround the central member 18 and the conductor elements 12 in order to further maintain and protect the integrity of the cable 10. A cavity within the cladding 20 is filled with a filler 22, e.g., a polymer in molten form that hardens to embed the elements 12 and the member 18 in place within the cladding 20. In one embodiment, discussed in more detail below, the filler medium 22 is a thermoplastic, which enables the medium to be at least partially melted or made molten and re-solidified. In a further embodiment, the filler medium 22 is Hytrel® brand thermoplastic elastomer commercially available from DuPont.

Once fully assembled, e.g., as described above, access to the elements 12 is not possible without disassembling the cable 10, as the elements 12 are encased in the cladding 20 and embedded in the filler medium 22. Access may be desired, for example, if the cable 10 is to be spliced to another cable or component such as a piece of monitoring equipment, a quick-connect docking assembly that enables lengths of fiber optic cables to be easily connected and disconnected, etc.

In order to gain access to the sensing cables, e.g., for enabling the cable 10 to be spliced, the following method is proposed according to aspects of the current invention. First, the cladding 20 is cut, peeled back, or removed in order to expose the filler medium 22. The filler medium 22 is then heated locally to a temperature that exceeds a transition temperature for the material 22 at which the material becomes soft and pliable enough for the elements 12 to be removed therefrom. The term “transition temperature” as used herein thus refers to some temperature at which the properties of the materials recognizably change, namely, the glass transition temperature (at which the material becomes at least partially molten), or the melting temperature of the material (at which the material undergoes a phase transition). A heat gun 24 is utilized in the illustrated embodiment to provide a stream of hot air for the localized heating of the filler material 22, although other sources of heat can be used in other embodiments.

Once softened, an operator or automated system can grip one or more of the elements 12 with tweezers, pliers, jaws, etc., designated with numeral 26, and pull the elements 12 out of the filler medium 22, e.g., such that the cable 10 can be spliced to another cable, component, or piece of equipment. As noted above, selecting the filler material 22 as a thermoplastic advantageously enables the filler material 22 to be melted or made molten, thereby permitting access of the elements 12, e.g., during splicing of the cable 10, and re-solidified thereafter so that the cable 10 can be used as intended. Furthermore, the softening of some materials suitable for use as the filler medium 22, such as the aforementioned Hytrel® brand thermoplastic elastomer, results in the material exhibiting some degree of translucency. In this way, the elements 12 can be optically identified to increase the efficiency and accuracy of the removal of the elements 12 from the material 22. Additionally, it is to be noted that areas of the cable 10 where the cladding 20 is still intact can be heated for enabling the elements 12 to be pulled out of the cable 10 along the length of the cable 10.

To prevent damaging the elements 12 during heating, the temperature provided by the heat source, e.g., the heat gun 24, can be set so that it does not exceed a corresponding transition temperature of the coating 16. That is, for example, the material of the coating 16 is selected so that it has a higher transition temperature than that of the filler medium 22 and the temperature of the heating operation is selected to be between these two transition temperatures. For example, a material such as polyether ether ketone (PEEK) provides suitable protection of the fiber optic strands 14 and can be used effectively as the coating 16. PEEK has a melting temperature of about 343° C., while the aforementioned Hytrel® brand thermoplastic elastomer has a melting temperature of about 200-225° C., depending on the particular composition of the material. In accordance with the above, the cable 10 can be heated to some amount, e.g., between 200° C. and 343° C. without adversely affecting the coating 16 on the fiber strands 14. Of course, other temperature ranges could be set for the heat source depending on the properties of the particular materials selected for the filler material 22 and the coatings 16. Additionally, some lower temperature corresponding to the glass transition temperature could be utilized if the medium 22 becomes sufficiently soft at its glass transition temperature to enable the elements 12 to be pulled out.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of accessing one or more conductor elements embedded in a solid medium in a cable, comprising:
heating the cable to a temperature that is greater than a first transition temperature corresponding to the medium and less than a second transition temperature corresponding to the one or more conductor elements;
softening the medium by the heating; and
removing at least one of the one or more conductor elements at least partially from the medium.

2. The method of claim 1, further comprising splicing the cable.

3. The method of claim 1, further comprising, prior to heating, opening a cladding of the cable to expose the medium.

4. The method of claim 1, wherein the first and second transition temperatures are glass transition temperatures.

5. The method of claim 1, wherein the first and second transition temperatures are melting temperatures.

6. The method of claim 1, wherein each of the one or more conductor elements comprises a protective coating.

7. The method of claim 6, wherein the second transition temperature relates to the coating.

8. The method of claim 6, wherein the protective coating encapsulates a fiber optic strand for each of the one or more conductor elements.

9. The method of claim 1, wherein the one or more conductors are operatively arranged to conduct signals, data, electrical power, or a combination including at least one of the foregoing.

10. The method of claim 1, wherein the one or more conductor elements are operatively arranged to sense one or more conditions or parameters.

11. The method of claim 10, wherein the one or more conditions or parameters is temperature, pressure, acoustics, strain, or a combination including at least one of the foregoing.

12. The method of claim 10, wherein the one or more conductor elements are disposed radially outwardly of a central member for the cable.

13. The method of claim 1, wherein heating includes applying a stream of hot air to a localized portion of the cable.

14. The method of claim 1, wherein the medium is a thermoplastic, a thermoplastic elastomer, or a combination including at least one of the foregoing.
